(19) United States
(12) Patent Application Publication
(10) Pub. No.: US 2010/0189608 A1
(43) Pub. Date: Jul. 29, 2010

(54) AIR DEODORIZER

(76) Inventor: Quan Chan, Vancouver (CA)

Correspondence Address: CAMERON IP, SUITE 1401 - 1166 ALBERNI STREET, VANCOUVER, BC, V6E 3Z3, CA

(21) Appl. No.: 12/360,810

(22) Filed: Jan. 27, 2009

(51) Int. Cl. B01J 19/00

(52) U.S. Cl. 422/122; 29/428

(57) ABSTRACT

There is disclosed an air deodorizing device for use in a refrigerator or a freezer. The air deodorizing device comprises a honeycomb structure disposed between a pair of permeable walls. The honeycomb structure has a plurality of honeycomb pores which extend between the permeable walls. The honeycomb pores are evenly filled with activated carbon. Also disclosed is a method of manufacturing the same.

### BACKGROUND OF THE INVENTION

1. Field of the Invention

The present invention relates to an air deodorizer and, in particular, to an air deodorizer for use in a refrigerator or freezer.

2. Description of the Related Art

Odor molecules from certain foods stored in a refrigerator often combine to produce a strong, unpleasant aroma which may alter the flavor of other stored foods. This is particularly true when foods with distinct odors such as onions, garlic, fish, or strong cheeses are stored in close proximity. Furthermore, in extreme cases, the presence of spoiled food may further exacerbate the unpleasant aroma.

In freezers odor molecules may become trapped in water, as ice cubes are formed, thereby contaminating the ice cubes. These odor molecules may later alter the flavor of drinks when the drinks are served with the ice cubes.

In view of the above, there have been numerous air deodorizers developed for use in a refrigerator or freezer.

One of the simplest air deodorizers used in a refrigerator or freezer is a partially opened container filled with sodium bicarbonate (baking soda). An example of such an air deodorizer is offered for sale by Church & Dwight Co. Inc. of 469 North Harrison Street, Princeton, N.J., 08543 under the trademark ARM & HAMMER. However, although sodium bicarbonate has odor absorbing properties, it is generally considered to be less effective than other compounds such as activated carbon. Other air deodorizers therefore utilize activated carbon as an odor absorbing agent.

U.S. Pat. No. 5,468,447 issued on Nov. 21, 1995 to Bermas and United States Patent Application Publication Number 2003/0136267 published on Jul. 24, 2003 in the name of Ku both disclose air deodorizers having a vented housing filled with activated carbon stored between a pair of permeable walls. The permeable walls allow air and odor molecules to freely flow therethrough but prevent the activated carbon from escaping into the immediate environment. Although the use of activated carbon increases the efficacy of these air deodorizers, they are also limited because the activated carbon is provided in flat beds between the permeable walls. This may lead to pillowing or bowing of the permeable walls resulting in the formation a gap between the activated carbon and the permeable walls. Air and odor molecules may flow through these gaps thereby avoiding the activated carbon and consequently reducing the effectiveness of the air deodorizer.

To mitigate against pillowing some air deodorizers are provided with a means to pack the activated carbon in order to fill any gaps formed between the activated carbon and the permeable walls. For example, U.S. Pat. No. 5,733,350 issued on Mar. 31, 1998 to Muller et al. discloses using foam pads to pack the activated carbon. In the air deodorizer disclosed by Muller et al. a foam pad extends between the permeable walls. The foam pad is compressed by the activated carbon as the air deodorizer is filled with activated carbon. When the activated carbon settles the foam pad expands causing the activated carbon to compress and fill any gaps which may have formed between the activate carbon and the permeable walls. However, expansion of the foam pad may also apply excess pressure to the permeable walls causing the walls to rupture.

There is therefore a need for an improved air deodorizer which overcomes the above-mentioned disadvantages of the prior art.

### SUMMARY OF THE INVENTION

It is an object of the present invention to provide an improved air deodorizer, for use in use in a refrigerator or freezer, and a method of manufacturing the same.

More specifically, it is an object of the present invention to provide a biodegradable air deodorizer filled with evenly separated particulates of activated carbon. This increases the exposure of the activated carbon and allows for maximum absorption of odor molecules in a refrigerator or freezer. It is also an object of present invention to provide a method of manufacturing a biodegradable air deodorizer filled with evenly separated particulates of activated carbon.

There is accordingly provided an improved air deodorizing device for use in a refrigerator or a freezer. The device comprises a honeycomb structure disposed between a pair of permeable side walls. The honeycomb structure has a plurality of honeycomb pores which extend between the permeable walls and the honeycomb pores are evenly filled with activated carbon.

In one embodiment the honeycomb structure is formed from a paper-based construction material and the permeable side walls are formed from a filter paper. Preferably the honeycomb pores have a diameter no greater than 1.5 cm and a length of between 3 cm and 4 cm. The air deodorizing device may further include a vented housing formed of a paper-based construction material.

There is also provided a method of manufacturing the improved air deodorizing block. The method comprises the steps of:
forming a honeycomb structure, the honeycomb structure having a plurality of open ended honeycomb pores extending therethrough;
sealing one side of the of honeycomb structure with a sheet of permeable material; filling the honeycomb pores with activated carbon; and
sealing another side of the honeycomb structure with another sheet of permeable material.

### BRIEF DESCRIPTION OF DRAWINGS

The invention will be more readily understood from the following description of preferred embodiments thereof given, by way of example only, with reference to the accompanying drawings, in which:

FIG. 1 is a perspective, side view of an improved air deodorizer device;

FIG. 2 is a plan, side view of the air deodorizer device of FIG. 1;

FIG. 3 is a plan, top view of the air deodorizer device of FIG. 1;

FIG. 4 is a perspective, exploded view of the air deodorizer device of FIG. 1;

FIG. 5 is a side view of an air deodorizing block of the air deodorizer device of FIG. 1;

FIG. 6 is a plan, side view, partially in section, of the air deodorizing block of FIG. 5;

FIG. 7 is a plan view of a blank used to form a frame of the air deodorizing block of FIGS. 5;

FIG. 8 is a perspective, side view of the frame of the air deodorizing block of FIG. 5;

FIG. 9 is perspective, side view of the frame and a permeable side wall of the air deodorizing block of FIG. 5;

FIG. 10 is a side view of a blank used to form a honeycomb structure of the air deodorizing block of FIG. 5;

FIG. 11 is a perspective, side view of the honeycomb structure formed from the blank of FIG. 10;

FIG. 12 is a perspective, side view of the frame and the honeycomb structure of the air deodorizing block of FIG. 5; and

FIG. 13 is a plan view of a blank used to form a housing of the air deodorizer device of FIG. 1.

### DESCRIPTION OF THE PREFERRED EMBODIMENTS

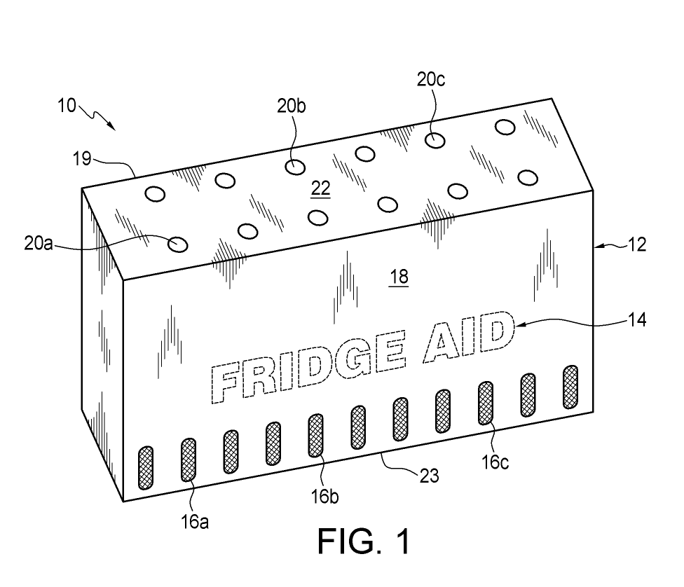

Referring to the drawings and first to FIG. 1, an improved air deodorizing device 10 for absorbing odor molecules in a refrigerator or freezer is shown. The device 10 includes a housing 12 which is preferably formed from a paper-based construction material such as recycled cardboard. This provides an environmental friendly, biodegradable housing to which designs or trademarks can be readily applied. In this example, a trademark 14 has been applied to the housing 12. FRIDGE AID is a registered trademark of Nu-Rich Enterprises Ltd. of 3338 Venables Street, Vancouver, British Columbia, Canada V5K 2S8. In other examples other trademarks may be applied to the housing 12. For example, the trademark ICE AID may be applied to device which designed for use in the freezer. ICE AID is also a registered trademark of Nu-Rich Enterprises Ltd.

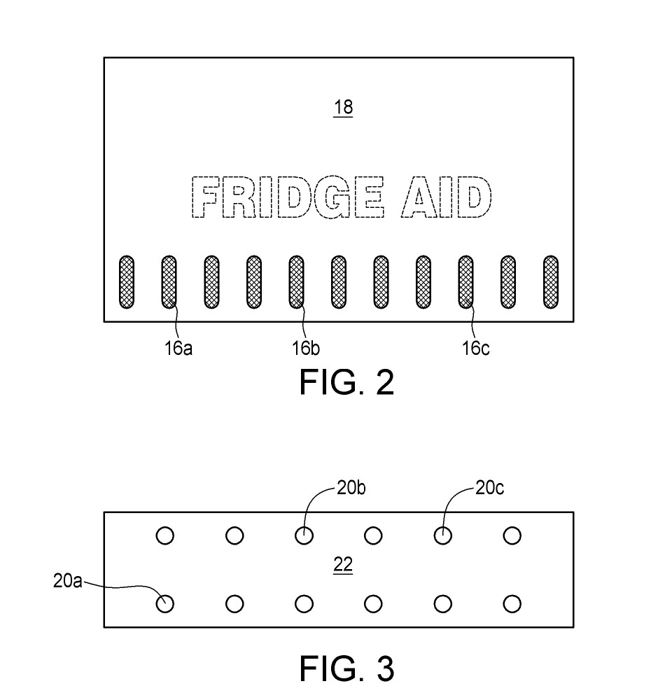

There is a plurality of openings 16a, 16b, and 16c extending through a first side 18 of the housing 12. There is also a plurality of openings 20a, 20b, and 20c extending through a top 22 of the housing 12. As best shown in FIG. 2, the openings 16a, 16b, and 16c extending through the side 18 of the housing 12 are in the form of spaced apart slots. As best shown in FIG. 3, the openings 20a, 20b, and 20c extending through the top 22 of the housing 14 are in the form of spaced apart circular apertures. It will be understood however that, in other examples, the size, shape, and location of the openings in the housing 12 may vary. The only requirement is that the housing 12 be vented to allow for the flow of air and odor molecules through the housing 12.

FIG. 1 clearly shows the first side 18 and the top 22 of the housing 12. A second side 19 and a bottom 23 of the housing 12 are best shown in FIG. 13. The first side 18 of the housing 12 and the second side 19 of the housing 12 are mirror images of one another, apart from the trademarks 14 and 15, and have a substantially similar structure which functions in a substantially similar manner. For example, the first side 18 of the housing 12 has a trademark 14 applied thereto and a plurality of openings 16a, 16b, and 16c extending therethrough. Likewise, the second side 19 of the housing 12 has a trademark 15 applied thereto and a plurality of openings 17a, 17b, and 17c extending therethrough. In this example, there are no openings extending through the bottom 23 of the housing 12. It will be understood by a person skilled in the art that the terms “top”, “bottom”, and “side” as used herein are used only in relation to the position of the air deodorizing device 10 as shown in FIG. 1.

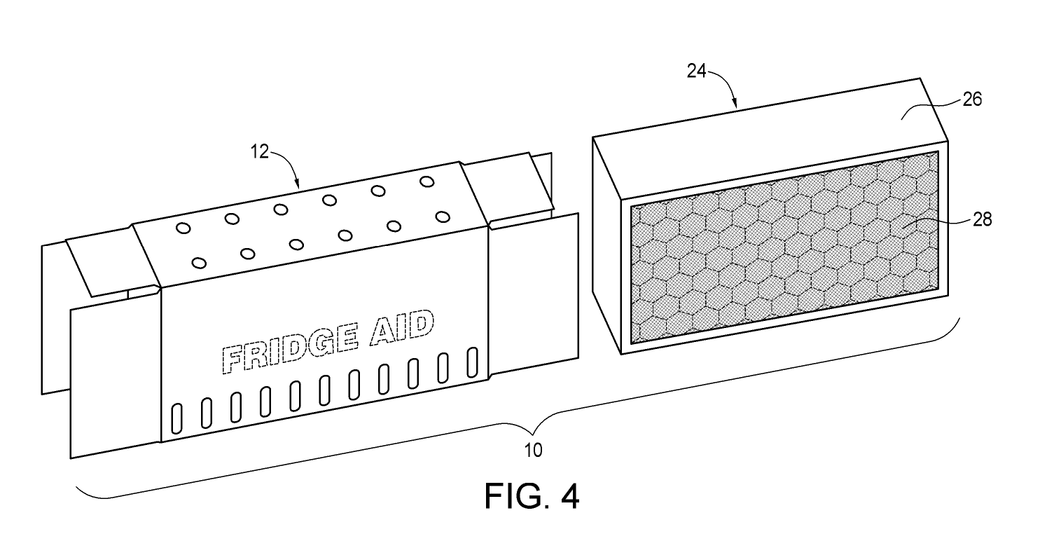

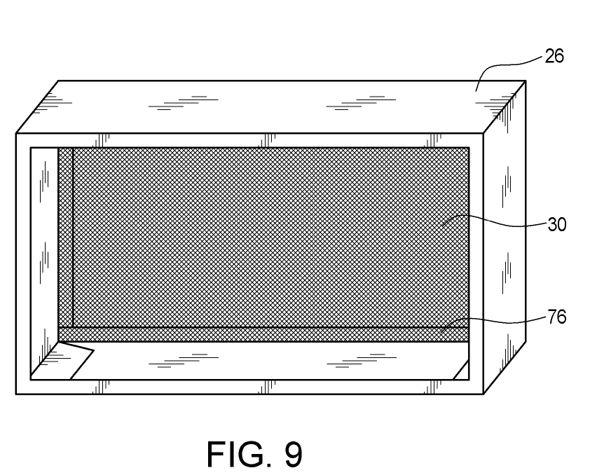

Referring now to FIG. 4, this shows an exploded view of the air deodorizing device 10 and, in particular, an air deodorizing block 24 which is disposed within the housing 12. The air deodorizing block 24 includes a frame 26 and a pair of opposite, permeable walls with only one of the permeable walls 28 being shown in FIG. 4. Another one of the permeable walls 30 is shown in FIG. 9. Similar to the housing 12, the frame 26 is preferably formed from a paper-based construction material such as recycled cardboard. The permeable walls 28 and 30 are preferably formed from a permeable paper-based material such as filter paper which is permeable to odor causing molecules. Non-woven polymeric materials which are permeable to odor causing molecules may also be used.

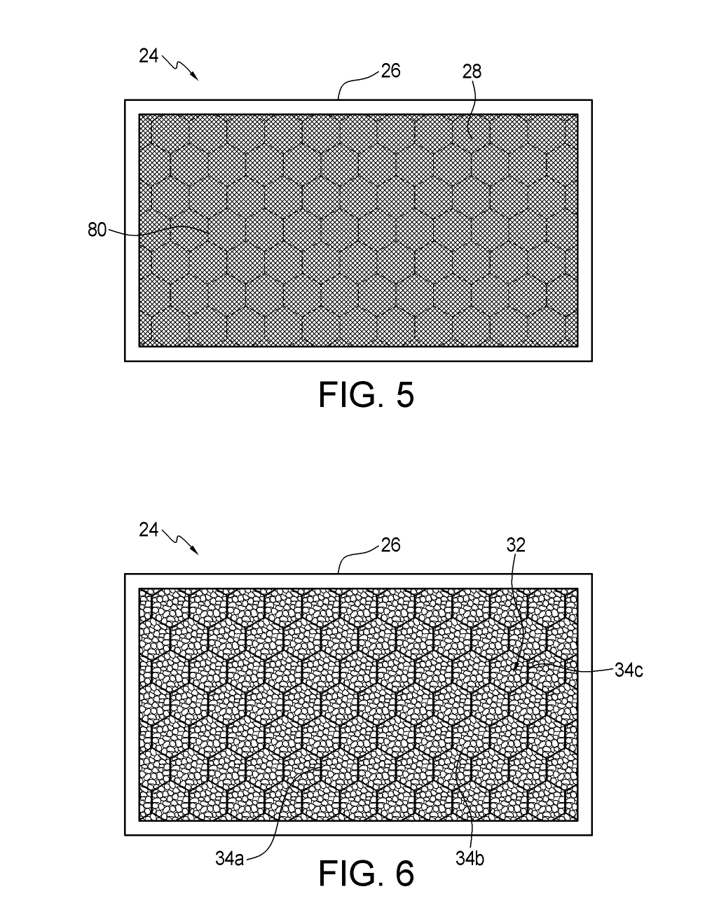

A side view of the air deodorizing block 24 is shown in both FIGS. 5 and 6. In FIG. 6 the permeable wall 28, shown in FIG. 5, has been removed. This exposes granular particulates of activated carbon 32 which are retained between the permeable walls 28 and 30. As best shown in FIG. 6, the granular particulates of activated carbon 32 are also retained within a plurality of honeycomb pores 34a, 34b, and 34c which extend between the permeable walls 28 and 30. The honeycomb pores 34a, 34b, and 34c allow the granular particulates of activated carbon 32 to be evenly separated within the air deodorizing block 24 to maximize its absorbency and effectiveness particularly in a low velocity air flow environments as typically found in a refrigerator. The honeycomb pores 34a, 34b, and 34c also minimize pillowing of the permeable walls 28 and 30.

It is not necessary for the air deodorizing block 24 to be disposed within the housing 12 for the air deodorizing block 24 to be effective. However, the housing 12 will restrict the leakage of activated carbon 32 should the permeable side walls 28 and 30 of the deodorizing block 24 somehow rupture. Furthermore, the housing allows for aesthetically pleasing designs to be applied to the air deodorizing device 10. This is desirable for domestic use. A manufacturer is also able to apply trademarks or advertising to the housing 12 to help boost brand recognition.

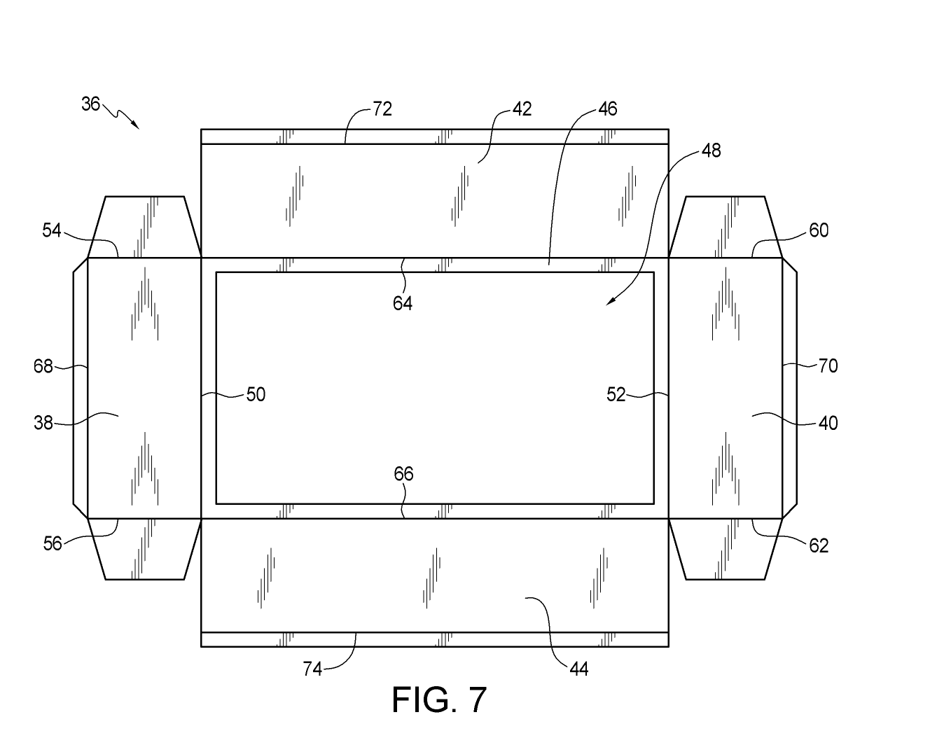

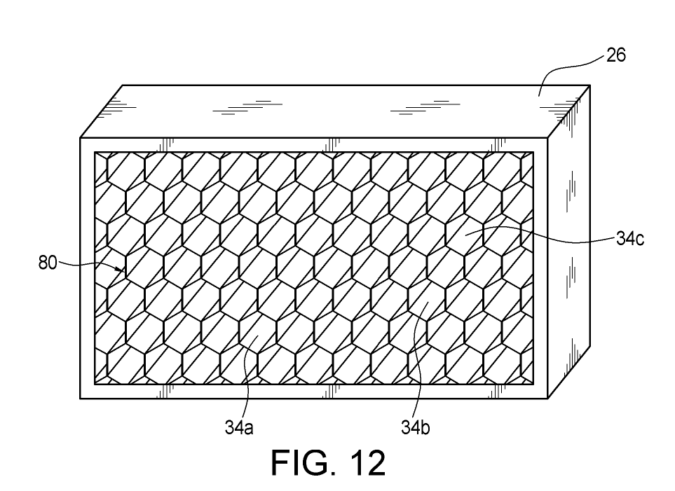

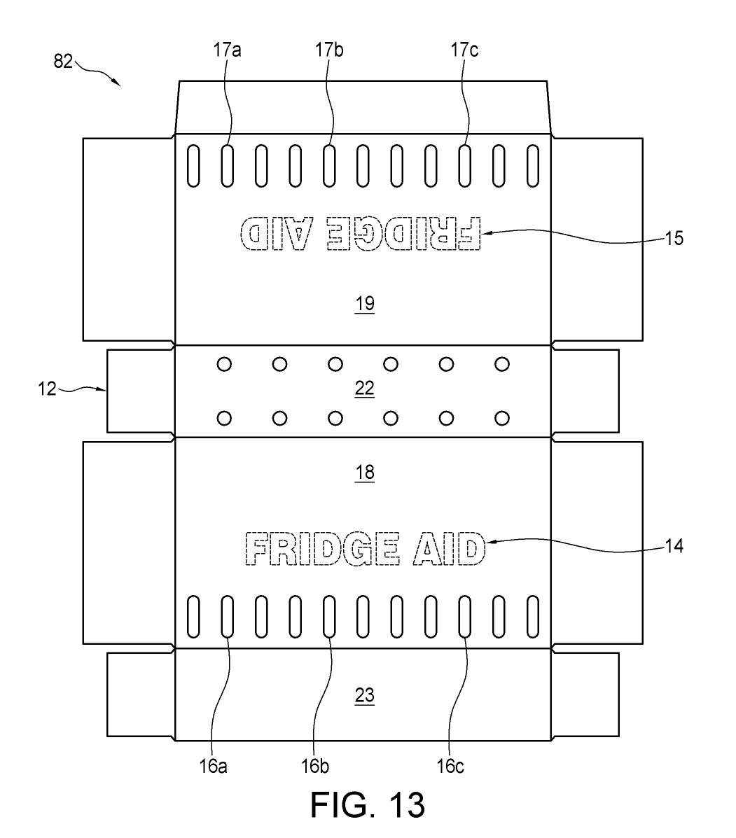

With reference to FIGS. 7 to 13 methods of manufacturing the air deodorizing device 10 disclosed herein will now be described. It will be understood that the methods of manufacturing the air deodorizing device 10 disclosed herein may be accomplished through manual processes, automated processes, or a combination of manual and automated processes.

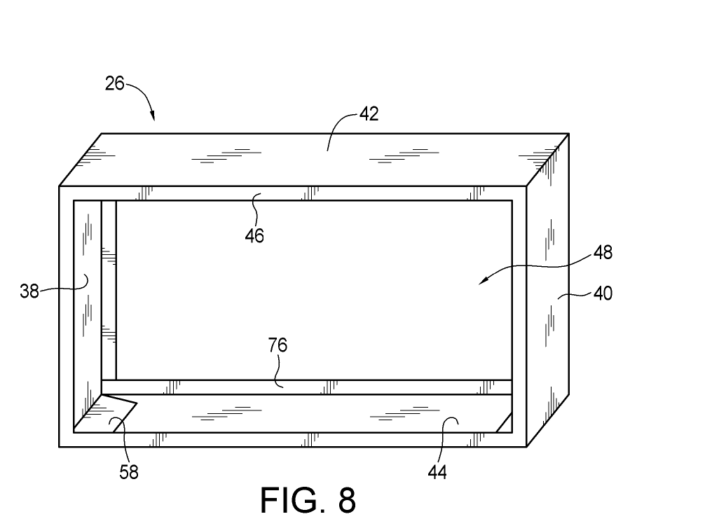

FIG. 7 shows a blank 36 which is used to form the frame 26 of the air deodorizing block 24. The blank 36 includes four flaps 38, 40, 42, and 44. Each of the flaps 38, 40, 42, and 44 extends along a respective edge of a border 46 which defines a quadrilateral opening 48 in the blank 36. To form the frame 26, first and second ones of the flaps 38 and 40 are folded 90 degrees along score lines 50 and 52, respectively. The first flap 38 is then further folded 90 degrees along score lines 54 and 56 to form a pair of opposed support tabs. One of these support tabs 58 is shown in FIG. 8. Referring back to FIG. 7, the second flap 40 is also folded 90 degrees along score lines 60 and 62 to form another pair of opposed support tabs.

After the support tabs are formed, an adhesive or fastener and preferably non-toxic glue is applied to support tabs such that the third and fourth ones of the flaps 42 and 44 may be secured to the support tabs when the flaps 42 and 44 are folded 90 degrees along score lines 64 and 66. This is best shown in FIG. 8 for the fourth flap 44 and one of the support tabs 58. Referring back to FIG. 7 the flaps 38, 40, 42, and 44 are finally folded along score lines 68, 70, 72, and 74 respectively and the corner ends of the of the flaps 38, 40, 42, and 44 are secured together with glue. As shown in FIG. 8, this results in another border 76 defining the quadrilateral opening 48 in the frame 26.

Referring now to FIG. 9, after the frame 26 is formed; one of the permeable walls 30 is secured to the frame 26. In this example, the border 76 defining the opening 48 in the frame 26 functions as a lip and provides a planar surface onto which glue may be applied. This allows the permeable wall 30 to be easily secured to the frame 26.

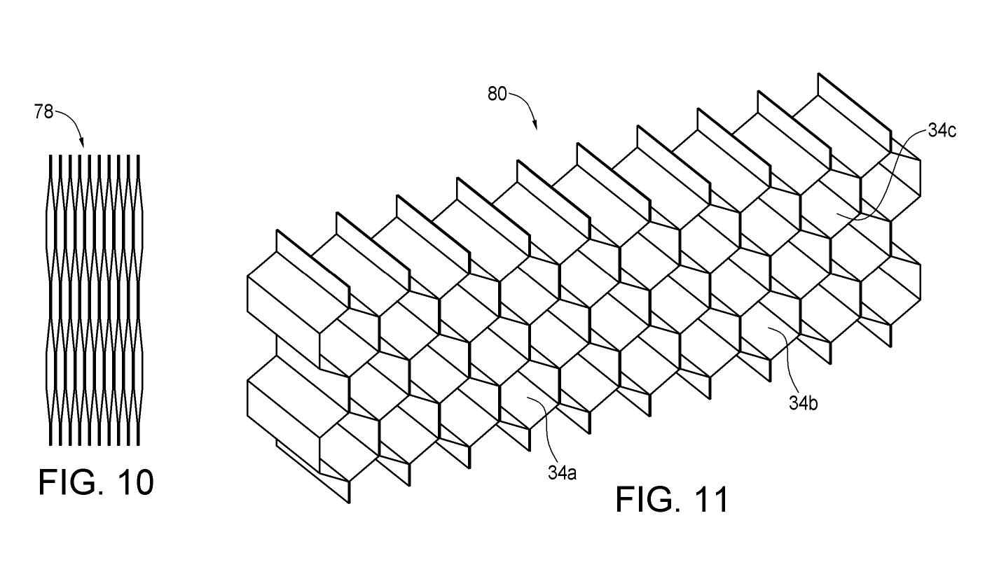

Referring now to FIG. 10 a honeycomb blank 78, which is preferably formed from a paper-based construction material such as recycled cardboard, is cut to an appropriate thickness so as it fit snugly in the between the borders 46 and 76 of the frame 26. In this example, the honeycomb blank 78 is cut to a thickness of between 3 cm and 4 cm, and preferably 3.5 cm; but in other examples other thicknesses may be used. The honeycomb blank 78 is then expanded, as shown in FIG. 11, to open the honeycomb pores 34a, 34b, and 34c and form a honeycomb structure 80. In this example, the honeycomb pores 34a, 34b, and 34c are open ended and open to maximum diameter of 1.5 cm, and preferably 0.6 cm, but in other examples other diameters may be used.

Glue is applied to one side of the honeycomb structure 80 and it is secured to the permeable wall 30 affixed to the frame 26. The honeycomb pores 34a, 34b, and 34c of the resulting structure, which is shown in FIG. 11, are then be filled with activated carbon as shown in FIG. 6. Glue is then applied to the other side of the honeycomb structure 80 and, as shown in FIG. 5, the other permeable wall 28 is secured to the honeycomb structure 80 to seal the air deodorizing block 24. The air deodorizing block 24 is then inserted into the housing 12 which is formed from a blank 82 shown in FIG. 13. The blank 82 used to form the housing is standard die cut box which is well known in the art and accordingly not described in further detail herein.

Another method of manufacturing the air deodorizing device 10 disclosed herein includes applying glue to one side of the honeycomb structure 80 and securing it directly to a sheet of permeable paper-based material. The honeycomb structure 80 is then cut into desired lengths and the honeycomb pores 34a, 34b, and 34c are filled with activated carbon. Glue is applied to the other side of the honeycomb structure 80 and the honeycomb pores 34a, 34b, and 34c are sealed with another sheet of permeable paper-based material. The sheets of permeable paper-based material accordingly form the permeable walls 28 and 30 of the air deodorizing block 24. A paper-based trim is cut to the same thickness of the honeycomb structure and glued around the edges of the honeycomb structure 80. The paper-based trim accordingly functions as the frame 26 of the air deodorizing block 24. The air deodorizing block 24 is then inserted into the housing 12 which is formed from a blank 82 shown in FIG. 13.

It will be understood by a person skilled in the art that many of the details provided above are by way of example only, and are not intended to limit the scope of the invention which is to be determined with reference to following claims.

1. An air deodorizing device for use in a refrigerator or a freezer, the device comprising:
a pair of permeable walls, the walls being permeable to odor molecules;
a honeycomb structure disposed between the permeable walls, the honeycomb structure having a plurality of honeycomb pores which extend between the permeable walls; and
activated carbon disposed within said honeycomb pores.

2. The air deodorizing device as claimed in claim 1 wherein the honeycomb pores have a length of between 3 cm and 4 cm.

3. The air deodorizing device as claimed in claim 1 wherein the honeycomb pores have a diameter no greater than 1.5 cm.

4. The air deodorizing device as claimed in claim 1 wherein the honeycomb structure is formed from a paper-based construction material.

5. The air deodorizing device as claimed in claim 1 wherein the permeable side walls are formed from filter paper.

6. The air deodorizing device as claimed in claim 1 further including a frame disposed about an edge of the honeycomb structure.

7. The air deodorizing device as claimed in claim 6 wherein the frame is formed from a paper-based construction material.

8. The air deodorizing device as claimed in claim 1 further including a vented housing, the walls, the honeycomb structure, and the activated carbon being disposed within the housing.

9. The air deodorizing device as claimed in claim 8 wherein the housing is formed from a paper-based construction material.

10. An air deodorizing device for use in a refrigerator or a freezer, the device comprising:
a vented housing; and
an air deodorizing block disposed within the vented housing, the air deodorizing block including, pair of permeable walls, the walls being permeable to odor molecules;
honeycomb structure disposed between the permeable walls, the honeycomb structure having a plurality of honeycomb pores which extend between the permeable walls;
a frame disposed about an edge of the honeycomb structure; and
activated carbon disposed within said honeycomb pores.

11. A method of manufacturing an air deodorizing device for use in a refrigerator or a freezer, the method comprising the steps of:
forming a honeycomb structure, the honeycomb structure having a plurality of open ended honeycomb pores extending therethrough;
sealing one side of the of honeycomb structure with a sheet of permeable material;
filling the honeycomb pores with activated carbon; and
sealing another side of the honeycomb structure with another sheet of permeable material.

12. The method as claimed in claim 11 further including the step of disposing the sealed, activated carbon filled honeycomb structure in a housing.

13. The method as claimed in claim 11 further including the step of providing a frame around the edges of the honeycomb structure.
